(19) United States
(12) Patent Application Publication
(10) Pub. No.: US 2006/0243801 A1
(43) Pub. Date: Nov. 2, 2006

(54) PC card device with express card

(76) Inventor: Frank Chen, Taipei Hsien (TW)

Correspondence Address: Frank Chen, 235 Chung - Ho, Box 8-24, Taipei, TW

(21) Appl. No.: 11/311,711

(22) Filed: Dec. 20, 2005

(30) Foreign Application Priority Data
Apr. 27, 2005 (TW) 094206583

(51) Int. Cl. G06K 7/06; G06K 19/06

(52) U.S. Cl. 235/441; 235/492

(57) ABSTRACT

A PC card device with an express card comprises an Express Card having an inserting end; a USB connector; and an adaptor; the adaptor having a circuit board; the circuit board being installed with a USB interface; one end of the adaptor being connected to the USB connector; another end of the adaptor having a conduction portion; the conduction portion being inserted into and electrically connected to an inserting end of the Express Card. In another design, one end of the adaptor is connected to the USB connector through a connecting wire. Another end of the adaptor has a conduction portion. The conduction portion is inserted into and electrically connected to an inserting end of the Express Card.

### FIELD OF THE INVENTION

The present invention relates to PC cards, and in particular to a PC card device with an Express Card for data storage and transmission. The Express Card can support a USB interface. Furthermore, it can be connected to a computer through a USB connecting port.

### BACKGROUND OF THE INVENTION

The Express Cards are a new kind of PC card for improve the prior art PC card and is disclosed by committee of PCI. The Express Card has two specifications, one is Express 54 and another is Express 34 which are determined by the sizes thereof. The Express Card has a compact size and has a high transmission speed. It is possible that in the near future, the Express Card will replace the CardBus PC card.

The Express Card can be communicated to a computer through a PCIE interface. However the computer must be added with the PCIE port, as shown in FIG. 1. The computer 10 is installed with a PCIE slot 11 for connecting with an Express Card 12. Other than PCIE, the Express Card donot support other interface. Thereby the use of the Express Card is limited.

### SUMMARY OF THE INVENTION

Accordingly, the primary object of the present invention is to provide a PC card with an Express Card for data storage and transmission. The Express Card can support a USB interface. Furthermore, it can be connected to a computer through a USB connecting port.

To achieve above objects, the present invention provides a PC card which comprises an Express Card having an inserting end; a USB connector; and an adaptor; the adaptor having a circuit board; the circuit board being installed with a USB interface; one end of the adaptor being connected to the USB connector; another end of the adaptor having a conduction portion; the conduction portion being inserted into and electrically connected to an inserting end of the Express Card. In another design, one end of the adaptor is connected to the USB connector through a connecting wire. Another end of the adaptor has a conduction portion. The conduction portion is inserted into and electrically connected to an inserting end of the Express Card.

Moreover in the present invention, a voltage sensing switch, a voltage converter, and a voltage switch are installed in the Express Card. The voltage sensor serves to sense whether the voltage is 5 V. If the voltage is 5 V, a signal is provided to the voltage switch so that the circuit of the Express Card is connected to the voltage converter to reduce the voltage from 5 V to 3 V to be provided to the Express Card. If the voltage is 3 V, a signal is also provided to the voltage switch so that the power is supplied to the Express Card.

The various objects and advantages of the present invention will be more readily understood from the following detailed description when read in conjunction with the appended drawing.

### BRIEF DESCRIPTION OF THE DRAWINGS

FIG. 1 is a schematic view about the insertion of the Express Card with a computer.

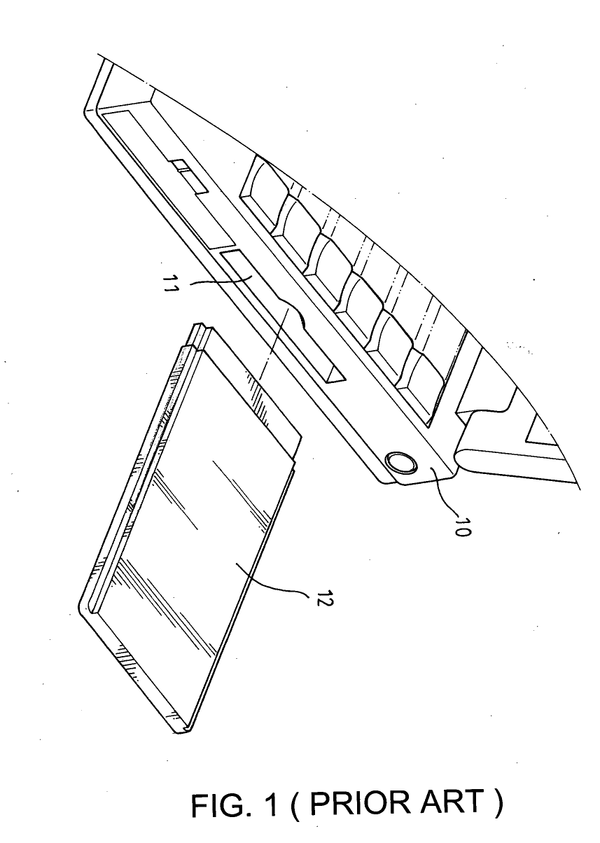

FIG. 2 is an exploded view of the present invention.

FIG. 3 is an assembled view of the present invention.

FIG. 4 shows the second embodiment of the present invention.

FIG. 5 is a circuit block of the adaptor for voltage matching to the Express Card.

FIG. 6 is a voltage matching circuit in the Express Card of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

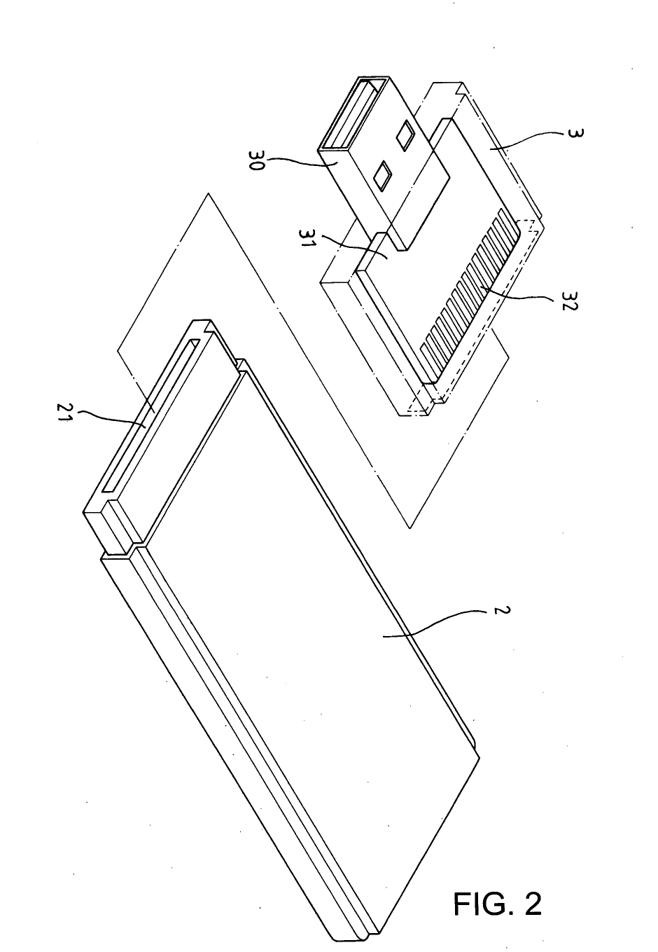

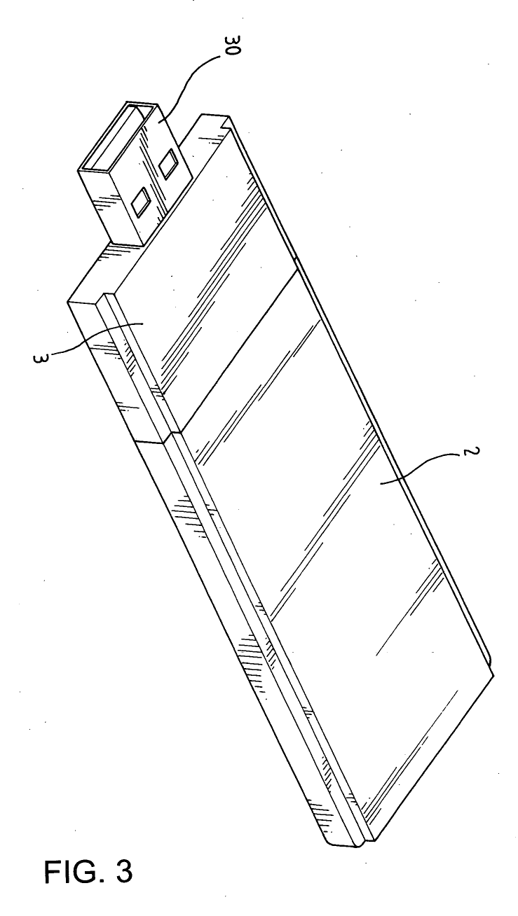

Referring to FIGS. 2 and 3, the structure of the present invention is illustrated. The PC card of the present invention includes the following elements.

An Express Card 2 has an inserting end 21.

A USB connector 30 is included.

An adaptor 3 is included. The adaptor 3 is connected to the USB connector 30. The adaptor 3 is built with a circuit board 31. The circuit board 31 has a USB interface. One end of the circuit board 31 is inserted into and electrically connected to an inserting end 21 of the Express Card 2 through a conduction portion 32. The shape of the adaptor 3 is matched to the inserting end 21 of the Express Card 2 so that the adaptor 3 can be engaged to the Express Card 2 as an integral body.

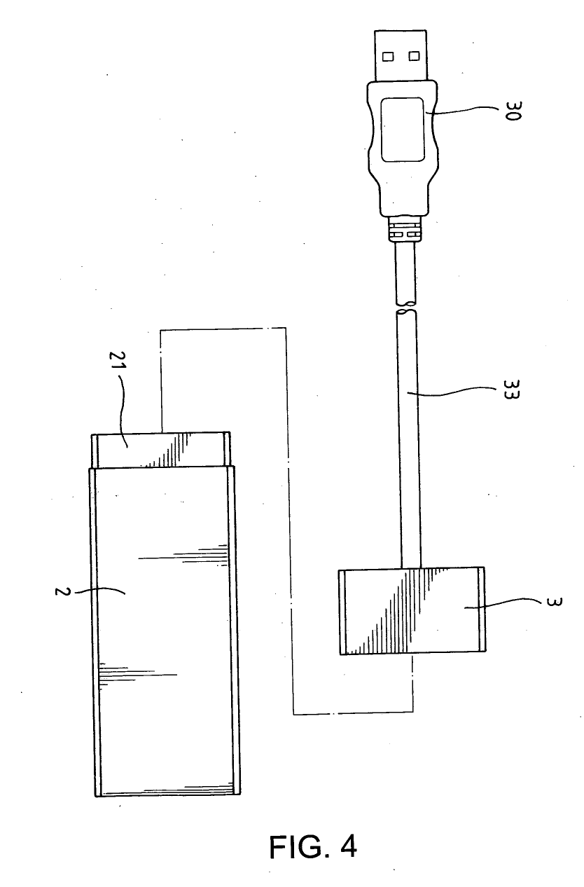

Referring to FIGS. 2 and 4, in another embodiment, the adaptor has a circuit board; the circuit board is installed with a USB interface; one end of the adaptor 3 is connected to the USB connector 30 through a connecting wire; another end of the adaptor has a conduction portion 32. The conduction portion 32 is inserted into and electrically connected to an inserting end of the Express Card.

Thereby the Express Card 2 can be extended to a farther location.

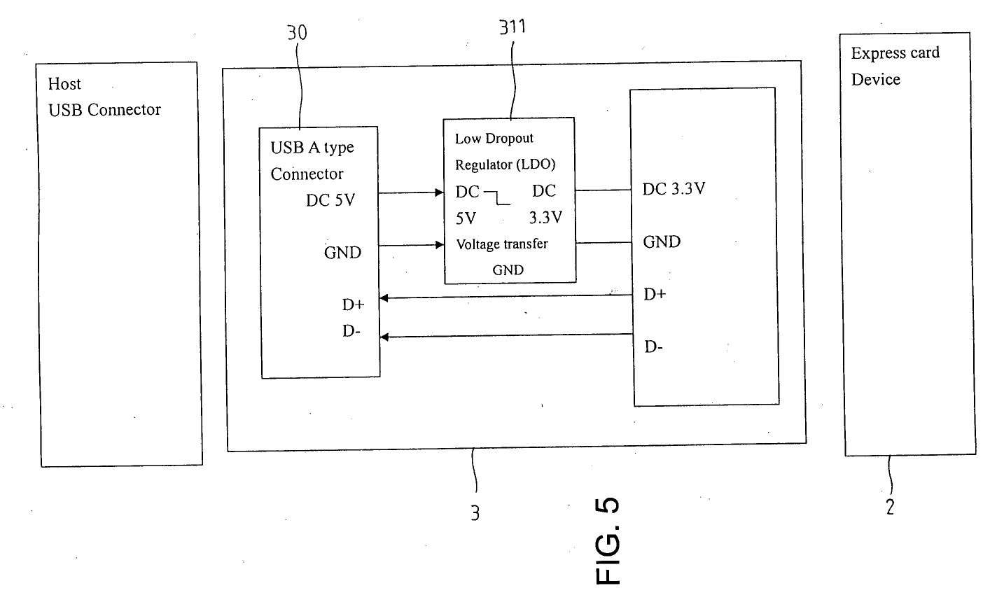

Referring to FIG. 5, generally, the power source of the USB interface is 5 V. The working power of the Express Card 2 is 3 V. Thereby a voltage conversion circuit 311 is built in the circuit board 31 of the adaptor 3 for conversion the voltages of the USB interface and the Express Card 2.

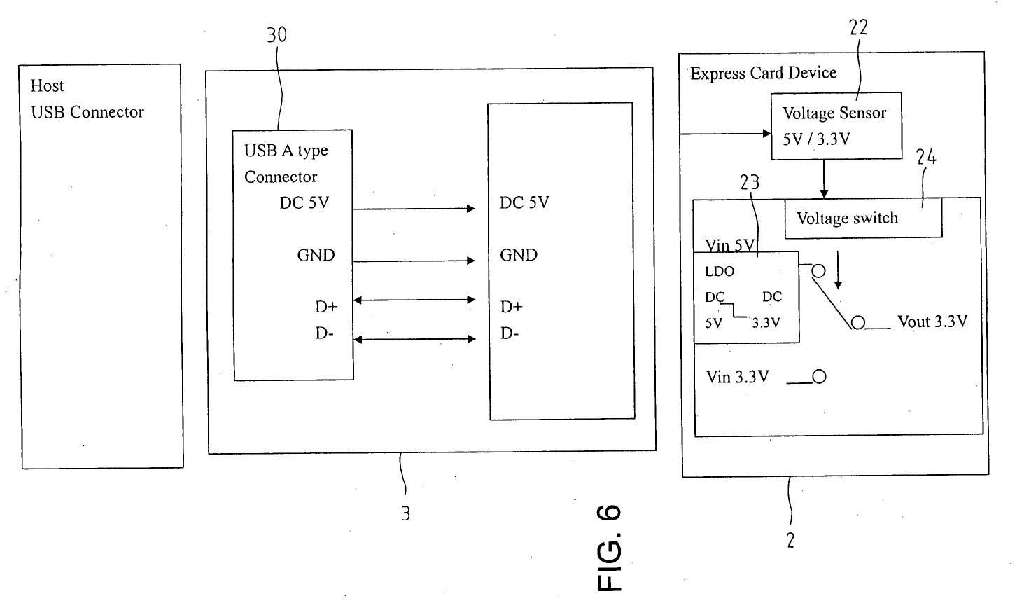

Referring to FIG. 6, a voltage sensing switch 22, a voltage converter 23, and a voltage switch 24 are installed in the Express Card 2. The voltage sensor 22 serves to sense whether the voltage is 5 V. If the voltage is 5 V, a signal is provided to the voltage switch 24 so that the circuit of the Express Card 2 is connected to the voltage converter 23 to reduce the voltage from 5 V to 3 V to be provided to the Express Card 2. If the voltage is 3 V, a signal is also provided to the voltage switch 24 so that the power is supplied to the Express Card 2.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A PC card device with an express card comprising:
an Express Card having an inserting end;
a USB connector; and
an adaptor; the adaptor having a circuit board; the circuit board being installed with a USB interface; one end of the adaptor being connected to the USB connector; another end of the adaptor having a conduction portion; the conduction portion being inserted into and electrically connected to an inserting end of the Express Card.

2. The PC card device with an express card as claimed in claim 1, wherein the shape of the adaptor is matched to the inserting end of the Express Card so that the adaptor is engaged to the Express Card as an integral body.

3. The PC card device with an express card as claimed in claim 1, wherein a voltage conversion circuit is built in the circuit board of the adaptor for conversing the voltage of the USB interface and the Express Card.

4. The PC card device with an express card as claimed in claim 1, wherein a voltage sensing switch, a voltage converter, and a voltage switch are installed in the Express Card; the voltage sensor serves to sense whether the voltage is 5 V; if the voltage is 5 V, a signal is provided to the voltage switch so that the circuit of the Express Card is connected to the voltage converter to reduce the voltage from 5 V to 3 V to be provided to the Express Card; if the voltage is 3 V, a signal is also provided to the voltage switch so that the power is supplied to the Express Card.

5. A PC card device with an express card comprising:
an Express Card having an inserting end;
a USB connector; and
an adaptor; the adaptor having a circuit board; the circuit board being installed with a USB interface; one end of the adaptor being connected to the USB connector through a connecting wire; another end of the adaptor having a conduction portion; the conduction portion being inserted into and electrically connected to an inserting end of the Express Card.

6. The PC card device with an express card as claimed in claim 5, wherein the shape of the adaptor is matched to the inserting end of the Express Card so that the adaptor is engaged to the Express Card as an integral body.

7. The PC card device with an express card as claimed in claim 5, wherein a voltage conversion circuit is built in the circuit board of the adaptor for conversing the voltages of the USB interface and the Express Card.

8. The PC card device with an express card as claimed in claim 5, wherein a voltage sensing switch, a voltage converter, and a voltage switch are installed in the Express Card; the voltage sensor serves to sense whether the voltage is 5 V; if the voltage is 5 V, a signal is provided to the voltage switch so that the circuit of the Express Card is connected to the voltage converter to reduce the voltage from 5 V to 3 V to be provided to the Express Card; if the voltage is 3 V, a signal is also provided to the voltage switch so that the power is supplied to the Express Card.
